(19) United States
(12) Patent Application Publication
(10) Pub. No.: US 2019/0214709 A1
(43) Pub. Date: Jul. 11, 2019

(54) ANTENNA ARRANGEMENT FOR WIRELESS VIRTUAL-REALITY HEADSET

(71) Applicant: INTEL IP CORPORATION, Santa Clara, CA (US)

(72) Inventors: Yaniv Haim Frishman, Kiryat Ono (IL); Tom Harel, Shefayim (IL); Yaniv Michaeli, Holon (IL); Raviv Weiss, Kiryat Ono (IL); Yaron Kahana, Santa Clara, CA (US); Sharon Talmor-Markovich, Kfar-Saba (IL); Ulun Karacaoglu, San Diego, CA (US); Atsuo Kuwahara, Portland, OR (US); Manish A. Hiranandani, Fremont, CA (US); Jie Gao, Synnyvale, CA (US); Dounia Baiya, San Jose, CA (US)

(21) Appl. No.: 16/325,601

(22) PCT Filed: Aug. 16, 2017
(86) PCT No.: PCT/US2017/047115

§ 371 Date: Feb. 14, 2019

Related U.S. Application Data
(60) Provisional application No. 62/375,744, filed on Aug. 16, 2016.
(60) Provisional application No. 62/375,762, filed on Aug. 16, 2016.

(51) Int. Cl. H01Q 1/27; G06F 1/16; H01Q 21/00; H01Q 21/06; G06F 3/01; H01Q 15/14; H01Q 1/44

(52) U.S. Cl. CPC H01Q 1/273; G06F 1/163; H01Q 21/0025; H01Q 1/44; H01Q 21/065; G06F 3/012; H01Q 15/14; H01Q 21/067

(57) ABSTRACT

A wireless head-mounted display (HMD) device to be worn on the head of a user includes a HMD body having a display device and a head-mount structure. Features of the HMD device, as well as in-situ operational configurations of the HMD system are described for supporting wireless communications with a content source situated at varying directions relative to the HMD device.

### CLAIM TO PRIORITY

This Application claims the benefit of U.S. Provisional Applications Ser. No. 62/375,744 and 62/375,762, each of which was filed Aug. 16, 2017, and the content of each being incorporated by reference in the present disclosure.

### TECHNICAL FIELD

Some aspects relate to millimeter-wave communication and wireless devices. Some aspects relate to head mounted displays (HMDs) for virtual reality (VR), augmented reality (AR), or mixed reality (MR). Some aspects relate to antennas. Some aspects relate to Wi-Gig communications.

### BACKGROUND

Virtual-reality (VR), augmented-reality (AR), or mixed-reality (MR) systems, hereinafter referred to simply as VR systems for the sake of brevity, provide an immersive experience for a user by simulating the user's presence in a computer-modeled environment, and facilitating user interaction with that environment. In typical VR implementations, the user wears a head-mounted display (HMD) that provides a stereoscopic display of the virtual environment. Some systems include sensors that track the user's head movement and hands, allowing the viewing direction to be varied in a natural way when the user turns their head about, and for the hands to provide input and, in some cases, be represented in the VR space.

Typically, the virtual-reality environment is modeled, and graphics are rendered, on a personal computer (PC), mobile device, or other computing platform implemented as a separately-housed device from the HMD. Placing the VR modeling and graphics rendering functions in a separate device from the HMD allows system designers to make the HMD smaller, lighter, less expensive, more energy-efficient, less heat-dissipative, and overall, more comfortable and affordable for users. Moreover, it allows for the use of higher-performance computing hardware to produce a better user experience. To date, the exchange of information between the HMD and computing platform has been accomplished using wired interfaces such as high-definition multimedia interface (HDMI), Universal Serial Bus 3.0, or the like. However, wired interfaces tend to limit the mobility of the wearer of the HMD, thus limiting the user experience.

Use of a wireless interface presents its own set of challenges, from ensuring reliable communications, effective radio-frequency (RF) transmission, propagation, and reception, operating interference-free and securely, meeting personal safety requirements concerned with RF exposure, and the like. In addition, high-throughput, low-latency, and robust wireless communications are essential for facilitating a good user experience in wireless-interfaced HMDs. For at least these reasons, to date, a practical wireless HMD solution has not been successfully commercialized.

### BRIEF DESCRIPTION OF THE DRAWINGS

FIG. 1 is a high-level system diagram illustrating some examples of hardware components of a VR system that may be employed according to some aspects.

FIG. 2 is a block diagram illustrating an exemplary communications circuitry in accordance with some aspects.

FIGS. 3A-3B are diagrams illustrating an assembly for connecting exemplary WiGig radio front end modules (RFEMs) including antennas to an HMD device according to an example.

FIG. 4 is a simplified top-view diagram illustrating an example arrangement of an RFEM holder assembly on a wireless HMD device, which is shown as it would be worn on the head of a user.

FIG. 5 is a diagram illustrating an exemplary wireless HMD with an omnidirectional antenna system arranged with a round form factor, and positioned on top of the HMD wearer's head, according to some examples.

FIG. 6A is a diagram illustrating a high-level arrangement of radiating elements belonging to an antenna assembly according to an embodiment. FIG. 6B is a plan-view diagram illustrating a related example of an antenna assembly having a generally cylindrical form factor defined by radiating elements enclosed in a polygonal-prismatic housing.

FIGS. 7A and 7B are diagrams illustrating example antenna arrangements of an antenna assembly according to various embodiments.

FIGS. 8A-8C are diagrams illustrating signal reflectors to improve communications coverage azimuth, elevation, or both, according to various embodiments.

FIG. 9 is a block diagram illustrating an example machine in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

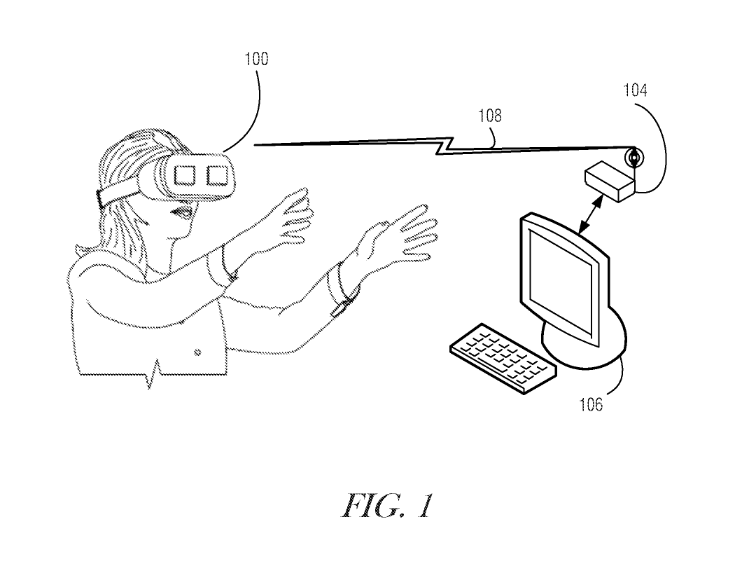

FIG. 1 is a high-level system diagram illustrating some examples of hardware components of a VR system that may be employed according to some aspects of the embodiments. HMD device 100 to be worn by the user includes a display facing the user's eyes and a HMD body on which the display is mounted, and which includes a head-mount structure, which may be a shell, band, or other suitable mechanism for securing the HMD to the head of a wearer. In various embodiments, the display may include stereoscopic, autostereoscopic, or virtually 3D display technologies. In a related embodiment, the HMD device may have another form factor, such as smart glasses, that offer a semi-transparent display surface.

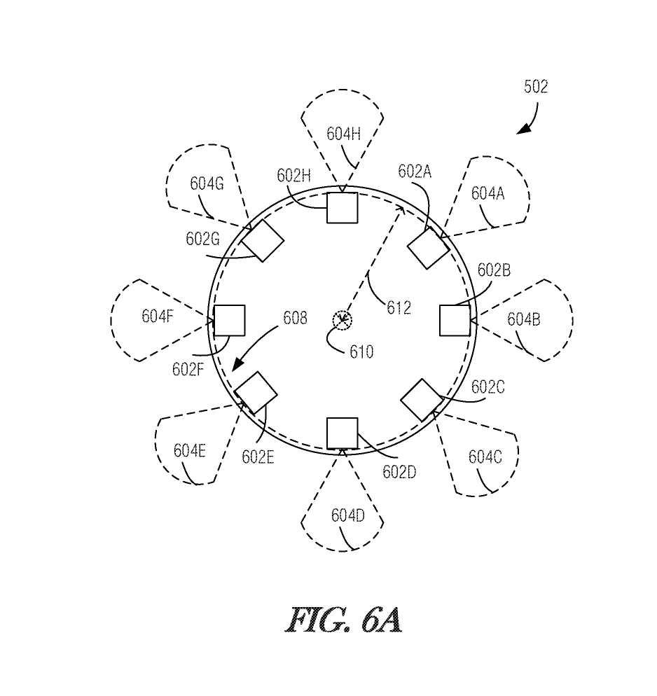

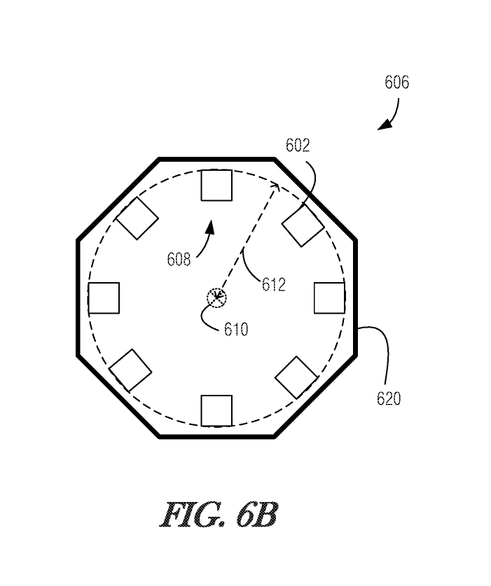

HMD device 100 utilizes two-way a wireless radio-frequency (RF) communications with VR-content source 104, which may be incorporated with, or otherwise coupled, to a computing platform 106. Computing platform 106 is described in greater detail below with reference to FIG. 6. The RF communications, indicated at 108, may be in the unlicensed 60 GHz frequency band. In a related embodiment, RF communications 108 are substantially in accordance with the IEEE 802.11ad or 802.11ay standards, sometimes referred to as wireless-gigabit (WiGig) technology. RF communications 108 replaces wired communication connections that would conventionally be used to carry data communications between the HMD device and the computing platform, thereby facilitating greater mobility for the wearer of HMD device 100. The absence of wired connections to HMD device 100 generally necessitates the inclusion of an on-board or user-portable energy store, such as battery cells, in (or connected to) HMD device 100.

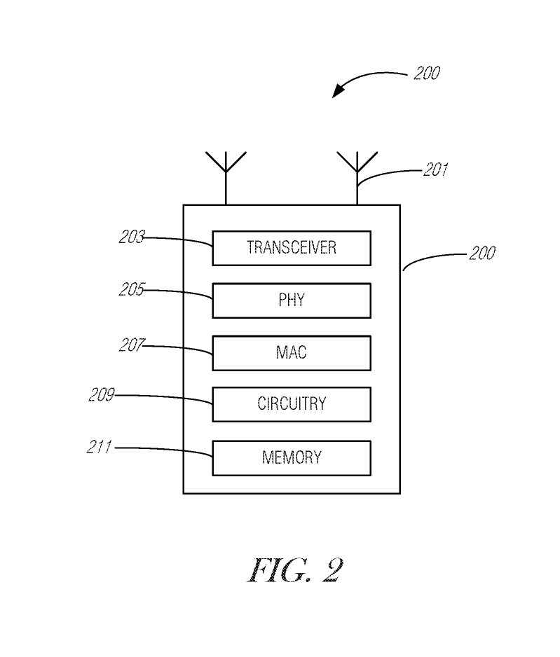

In some embodiments, RF communications 108 are facilitated by communications circuitry at HMD device 100 and VR-content source 104. FIG. 2 is a block diagram illustrating communications circuitry 200 in accordance with some embodiments. Communications circuitry 200 may include a millimeter-wave (mmWave) compliant station (STA) device that may be arranged to communicate with one or more other STA devices or one or more master stations (MSs). In some embodiments, communications circuitry 200 may include, among other things, a transmit/receive element 201 (for example, an antenna or array of antennas), a transceiver 203, physical (PHY) circuitry 205, and media access control (MAC) circuitry 207. PHY circuitry 205 and MAC circuitry 207 may be mmWave compliant layers and may also be compliant with one or more other IEEE 802.11ax or IEEE 802.13 standards. MAC circuitry 207 may be arranged to configure packets such as a physical layer convergence procedure (PLCP) protocol data unit (PPDUs) and arranged to transmit and receive PPDUs, among other things. Communications circuitry 200 may also include circuitry 209 configured to perform the various operations described herein. The circuitry 209 may be coupled to the transceiver 203, which may be coupled to the transmit/receive element 201. While FIG. 2 depicts the circuitry 209 and the transceiver 203 as separate components, the circuitry 209 and the transceiver 203 may be integrated together in an electronic package or chip.

In some embodiments, the MAC circuitry 207 may be arranged to contend for a wireless medium during a contention period to receive control of the medium for an appropriate control period and configure a high-efficiency WLAN Physical Layer Convergence Protocol (PLCP) Protocol Data Unit (HEW PPDU). In other embodiments, a scheduled wireless channel-access scheme, rather than contention-based scheme, is utilized. In some embodiments the PHY circuitry 205 may be arranged to transmit 5G mmWave packets. In some embodiments, the MAC circuitry 207 may be arranged to contend for the wireless medium based on channel contention settings, a transmitting power level, and a Clear Channel Assessment (CCA) level.

In some embodiments the PHY circuitry 205 may be arranged to transmit the HEW PPDU. The PHY circuitry 205 may include circuitry for modulation/demodulation, upconversion/downconversion, filtering, amplification, and the like. In some embodiments, the circuitry 209 may include one or more processors which may be configured for parallel processing. The circuitry 209 may be configured to perform functions based on instructions being stored in a RAM or ROM, or based on special purpose circuitry. The circuitry 209 may include processing circuitry and/or transceiver circuitry in some embodiments. The circuitry 209 may include a processor such as a general purpose processor or special purpose processor. The circuitry 209 may implement one or more functions associated with transmit/receive elements 201, the transceiver 203, the PHY circuitry 205, the MAC circuitry 207, and/or the memory 211.

In some embodiments, the transmit/receive elements 201 may be two or more antennas that may be coupled to the PHY circuitry 204 and arranged for sending and receiving signals including transmission of the HEW packets. The transceiver 202 may transmit and receive data such as HEW PPDU and packets that include an indication that the communications circuitry 200 should adapt the channel contention settings according to settings included in the packet. The memory 211 may store information for configuring the other circuitry to perform operations for configuring and transmitting HEW packets and performing the various operations to perform various other functions.

In some embodiments, the communications circuitry 200 may be configured to communicate using OFDM communication signals over a multicarrier communication channel. In some embodiments, communications circuitry 200 may be configured to communicate in some one or more specific communication standards, such as the Institute of Electrical and Electronics Engineers (IEEE) standards including IEEE 802.11-2012, 802.11n-2009, 802.11ac-2013, 802.11ad, 802.11ax, 802.11ay, DensiFi, standards and/or proposed specifications for WLANs, or other standards as described in conjunction with FIG. 2, although the scope of the embodiments is not limited in this respect as they may also be suitable to transmit and/or receive communications in some other techniques and standards. In some embodiments, the communications circuitry 200 may use 4× symbol duration of 802.11n or 802.11ac.

The transmit/receive element 201 may comprise one or more directional antennas, including, for example, a phased array, directional beam antenna. In millimeter wave (mm-Wave) wireless communications, highly directional transmissions are used for wireless communication. This is to compensate for high isotropic path loss.

According to some embodiments, in order to improve wireless performance, an antenna design is provided for VR HMD devices where support is provided for full (e.g., 360 degree) coverage, which allows the wearer to roam freely in the immediate environment (e.g. typically defined as allowing movement in a 5 m×5 m area such as a living room). In related embodiments, the WiGig antennas are integrated on the HMD device, which may include additional sensors/emitters on its external surface. In a related aspect, RF-radiation safety rules are met by spacing the antenna from the wearer.

Some aspects are directed to placement of antennas on the HMD device. Related aspects are directed to the use of reflective surfaces in the room to enhance the coverage.

According to one embodiment, two antenna arrays (each containing a set of radiating elements) are used on the HMD device. In another approach, more antenna arrays (e.g. 4 or 8 antenna arrays) are used to provide 360-degree coverage.

The arrangement according to some embodiments places the antennas in a spaced relationship from the body of the HMD device wearer. This reduces radiation safety issues.

In a related embodiment, two antenna arrays are arranged at an angle relative to one another such that their radiation patterns slightly overlap. For example, two antenna arrays may be arranged with an angle of between 125 and 145 degrees between them. Depending on their radiation pattern, this arrangement may provide coverage for approximately 240 degrees.

Some embodiments prioritize the “forward looking” direction by placing the antenna arrays in a generally-forward facing arrangement on the HMD device. For backward-facing head positions of the wearer, one or more reflectors may be placed in the room to improve wireless coverage, as will be described in greater detail below.

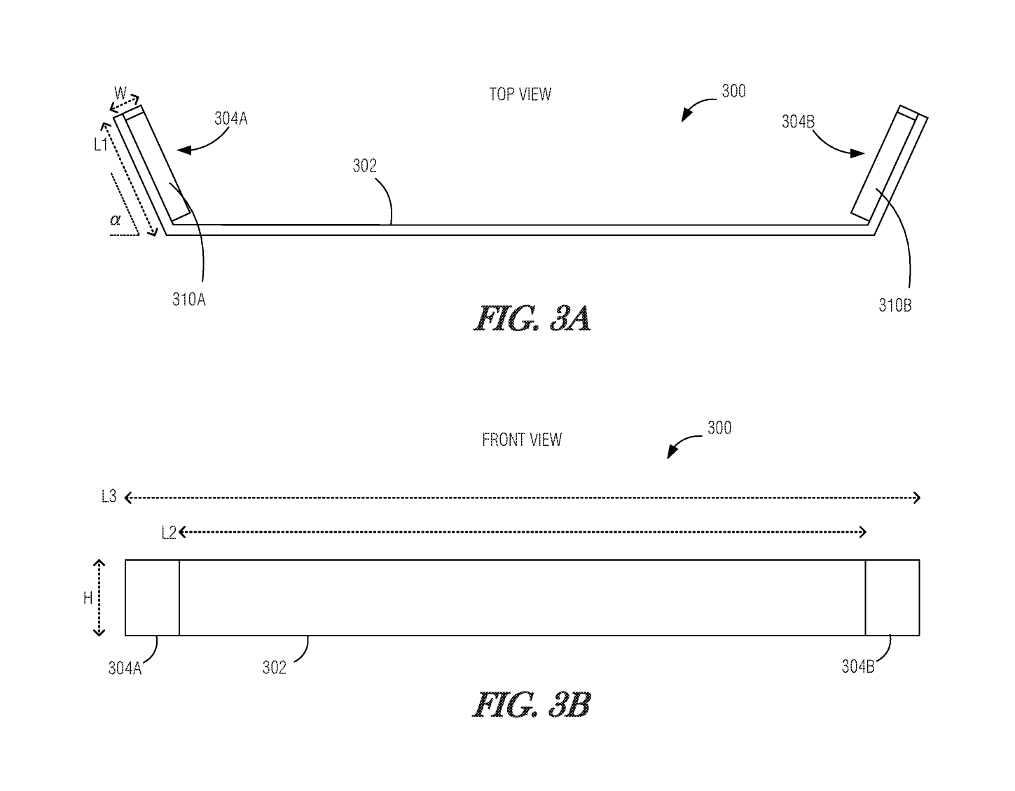

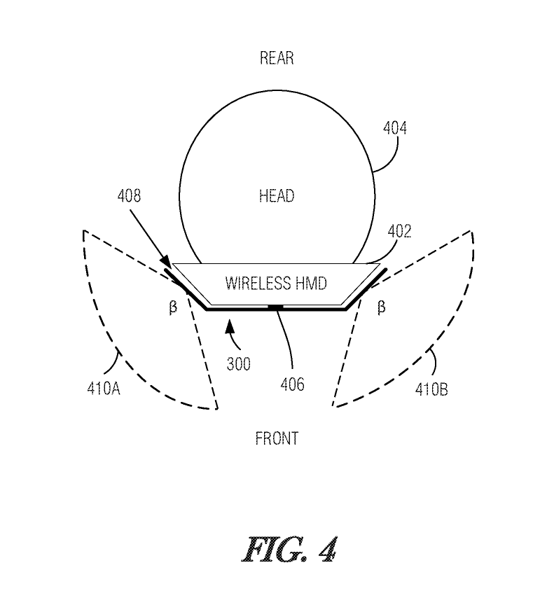

FIGS. 3A-3B are diagrams illustrating an assembly for attaching WiGig radio front end modules (RFEMs) 310A, 310B, which include antennas (not shown) to an HMD device according to an embodiment. FIG. 3A is a top view diagram, whereas FIG. 3B is a front-view diagram of the RFEM holder assembly 300. RFEM holder assembly 300 as illustrated includes a base portion 302, and angled extension portions 304A, 304B. RFEMs 310A, 310B are situated on angled extension portions 304A, 304B, respectively. Each angled extension portion 304 is angled with an angle α relative to the major dimension of base portion 302 as illustrated. Each angled extension portion 304 also has a length L1 and a width W, as illustrated. Various angles may be used for α such as, for example, angles in the range of 60-75 degrees. RFEM holder assembly 300 may be made from any suitable material, such as acrylic or polycarbonate thermoplastic, for example. Depending on the HMD application or style, RFEM holder assembly 300 may be opaque or transparent.

One example embodiment provides wide, and slightly-overlapping, coverage for the frontal direction, which is typically where the user faces most of the time. For instance, with an α of 65 degrees, angled extension portions 304A, 304B are offset from one another by 130 degrees. Other arrangements may be utilized, such as with a 145-degree offset. Referring to FIG. 3B, the front view shows length L2 of the base portion 302, an overall length L3 along the major dimension, and height H along the minor dimension. Example dimensions according to an embodiment may be L2=188 mm, L3=218 mm, and H=20 mm. Example dimensions for angled extension portions 304 may be w=5 mm and L1=30 mm.

FIG. 4 is a simplified top-view diagram illustrating an example arrangement of RFEM holder assembly 300 on a wireless HMD device 402, which is being worn on the head of a user 404. Notably, the RFEM holder assembly 300 is attached to the body of the wireless HMD device 402 by a spacer 406 that establishes a gap 408 between the radiating elements of RFEMs 310A, 310B (FIG. 3A) and HMD device 402. Also depicted are the respective ranges 410A, 410B of steerable beam directionality from each RFEM 310A, 310B. Ranges 410A, 410B each have an angle I over which the beams may be directed. One example of angle β is 120 degrees. According to some embodiments, angle a is slightly less than β/2 to ensure that there is some overlap of ranges 410A, 410B of steerable beam directionality at some distance in front of the wireless HMD device.

The specific placement of the RFEMs 310 (FIG. 3A) has several advantages. The coverage for forward-looking directions is good, especially when assuming some practical distance between the source RFEM of the base station (e.g., connected to the PC generating the VR display content) and the HMD device 402, where the ranges 410 of steerable beam directionality overlap. The RFEMs 310 are on the sides of the HMD, having a forward component in their respective ranges 410 of steerable beam directionality, as well as backwards components, allowing better signal quality on the side lobes of the RFEM and in the backward-radiating direction. The RFEMs 310 are in spaced relationship with the head of the user 404. In an example embodiment, the gap 408 is on the order of 3 cm. In other embodiments, the gap 408 is 5 cm, 8 cm, 10 cm, or 12 cm. Other gap sizes are also contemplated, which are suitable to allow sufficient transmit power to be used for reliable communications performance while meeting applicable safety guidelines (e.g., RF absorption).

In related embodiments, the RFEM holder 300 has apertures through the base portion 302 to provide line-of-sight access to forward-facing cameras or other sensors or emitters, such as infrared positioning emitters, that may present on the HMD device 402.

In a related embodiment, the RFEM holder 300 may be attached only to the corners or sides of HMD device 402 (instead of spanning the body of the RFEM holder between the two RFEMs) in order to avoid blocking any sensors or emitters.

In a related aspect, some embodiments are directed to a HMD and RFEM arrangement that supports a more complete (e.g., 360 degree) range of coverage. Advantageously, the complete range of coverage according to some embodiments allows the HMD wearer to roam freely in the immediate environment (e.g. typically defined as allowing movement in a 5 m×5 m area such as a living room or office). In in some embodiments, WiGig antennas are integrated on the HMD device, which may include additional sensors/emitters on its external surface. As a related aspect, RF-radiation safety rules are met by spacing the antenna from the wearer.

Accordingly, some aspects are directed to placement of antennas on the HMD device. Related aspects are directed to the use of reflective surfaces in the room to enhance the coverage.

Some embodiments focus on a wireless Virtual Reality (VR) HMD having a phased-array antenna that a) meets the VR spatial coverage antenna gain requirements, b) has an architecture optimized for power consumption, latency and other VR user experience-centric key performance indicators (KPIs), and c) The phased array design is optimized to radiate most of its energy away from the user for meeting the applicable regulatory requirements for mm-wave modules on a HMD, without too much power reduction, in close proximity to the human head.

According to some embodiments, a single mm-wave phased array antenna is provided for a HMD that would provide complete spatial coverage in a typical VR usage scenario.

When the single phased array is designed to meet the spatial coverage requirements, additional phased arrays may not be needed; thus, some optimization of RFIC architecture for lower power consumption, reduced latency and other critical KPIs may be realized.

According to some examples, a particular location in which the array is placed on the HMD, and the shape of the radiation pattern to radiate away from the wearer's head (as a function of the antenna elements, their spacing and the design of the array aperture), provides for lower absorption of the radiated energy into the head of the wearer, thus allowing for greater transmission power to be used to improve system performance.

Some conventional mm-wave radio systems use two different types of RFEMs that are designed for an end-to-end WiGig wireless docking link in an enterprise environment: one on the side of the VR-content source and another on the side of the HMD. The RFEMs operating at the HMD side are each generally designed to give 100-120 degrees of azimuth coverage. In some cases, the WiGig HMD uses two RFEMs and picks the better of the two. At any instant, a total of 200-240 degrees of coverage may be available, depending on the minimum gain appropriate for use within that coverage area. The RFEMs may be placed such that one is at the front of the HMD, and the other at the back of the HMD, to spread the coverage primarily in the forward and backward directions, with some gaps in coverage along the sides. Using a solution with two RFEMs generally calls for careful scheduling between the two RFEM modules, that results in higher power consumption and increased latency, both of which are critical metrics to be minimized for VR usage. Additionally, when using two RFEM modules that give 360 degree azimuth coverage, the azimuth gain distribution has quite a bit of variation and the elevation angles can easily hit a blind spot when the user bends upwards or downward, which is not uncommon in VR applications.

According to some examples, the scheduling and switching between the multiple RFEMs is obviated by using only one RFEM having sufficient isotropic coverage, thereby improving latency and power consumption. The spatial coverage problems may be addressed by the design of the phased array, that provides complete or nearly-complete spatial coverage to suit typical VR usages. The phased array design may also ensure that most of the energy is spread outwardly, and not directed towards the human head, thus meeting safety guidelines while allowing for greater power transmission to further improve wireless HMD performance.

According to some examples, an omnidirectional antenna system is provided in a generally cylindrical form factor. In the present context, a generally cylindrical form factor has a height dimension and a round or polygonal base that has radial symmetry about a reference axis situated along the height dimension. Examples of base shapes include circular, elliptical, triangular, square, pentagonal, hexagonal, heptagonal, octagonal nonagonal, decagonal, and other polygonal shapes having greater numbers of sides.

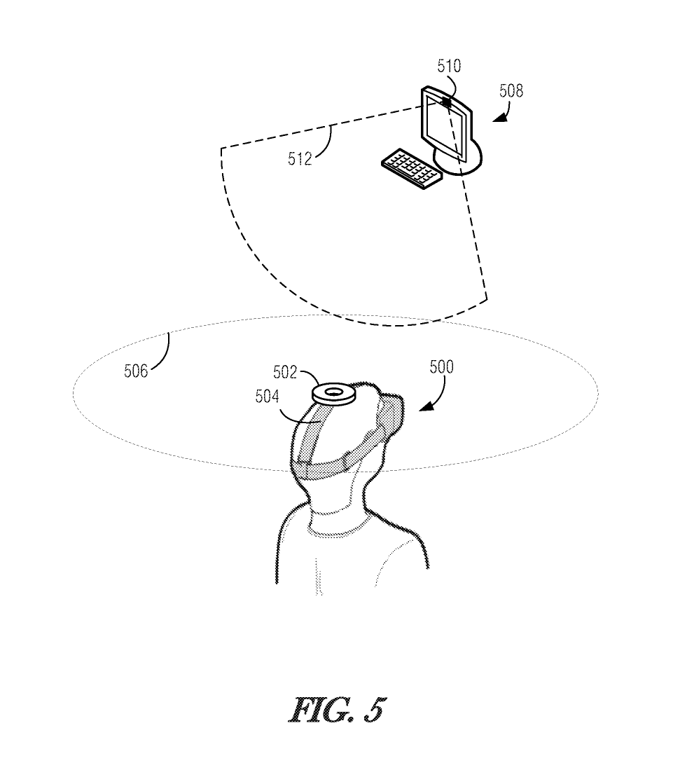

The omnidirectional antenna system, in its generally cylindrical form factor, is positioned on a portion of the HMD that is situated on top of the wearer's head when the HMD is properly worn. An example is illustrated in FIG. 5, representing some examples. As illustrated, a wireless HMD 500 includes an antenna assembly 502, which may include a multi-antenna array, situated on an over-head portion 504 of the HMD. Antenna assembly 502 in this example has an annular-cylindrical housing and comports to a generally cylindrical form factor. Being situated on top of the head, antenna assembly 502 facilitates line-of-site communications capability in all azimuths by virtue of not having any nearby obstructions from the HMD or the user's anatomy, depicted as communication range 506.

In a related example, antenna assembly 502 includes RFEM circuitry housed in the cylindrical form factor. In another example, the RFEM circuitry is housed elsewhere in the HMD outside of the cylindrical form factor.

FIG. 5 further depicts a VR-content source 508 having a VR-content source-side RFEM 510. VR-content source-side RFEM 510 has a communication range indicated at 512, with an angle of coverage (e.g., 120 degrees).

FIG. 6A is a plan-view diagram illustrating a high-level arrangement of radiating elements 602A-602H of omnidirectional antenna assembly 502 according to an example. As depicted, omnidirectional antenna assembly 502 includes a plurality of radiating elements 602A-602H situated along the circumference of cylindrical form factor 608. The cylindrical form factor 608 is defined by radiating elements 602A-602H being situated at a radius 612 from reference center axis 610.

Each radiating element 602A-602H is arranged to direct transmissions outwardly, as indicated by individual transmission coverage areas 604A-604H, respectively. Coverage areas 604A-604H also represent the receive directionality of radiating elements 602A-602H, respectively. Each one of coverage areas 604A-604H overlaps with at least its adjacent two coverage areas at a distance of about 1 meter from the HMD, thereby collectively achieving 360 degrees of un-interrupted coverage.

In an example, radiating elements 602A-602H may be arranged as a single row, distributed around the circumference of antenna assembly 502, on the azimuth plane to provide uniform transmission and reception in all directions, thereby allowing the flexibility for the user to move around freely. These radiating elements 602A-602F may be dynamically assigned into a pre-defined number of sub-arrays that, collectively, cover the 360 degrees in azimuth and at least 140 degrees in elevation. Given the number of elements in the azimuth, this example has a narrow beam with high gain in azimuth and a much wider beam width in elevation.

In various examples, radiating elements 602A-602F may be operated in the dynamically-selectable sub-arrays as phased-array elements to increase gain and provide beam-steering functionality. In other examples, radiating elements 602A-602F may be selectively operated individually or in groups to select the general direction of transmission or reception.

FIG. 6B is a plan-view diagram illustrating a related example of an antenna assembly 606 having a generally cylindrical form factor 608 defined by radiating elements 602 enclosed in an octagonal housing 620. This example illustrates that the exterior appearance of housing 620, being octagonal (and not strictly cylindrical), nonetheless allows antenna assembly 606 to have a generally cylindrical form factor. It will be appreciated that various other housing shapes may be employed.

In related examples (not shown), the generally cylindrical form factor may be defined by multiple radii 612, which may have different lengths to create elongated or irregular shapes of the base.

Given that 360 degrees of coverage is desired for the VR usage, and this may be achieved with one circular phased array of radiating elements, the size is obtained by a process of antenna synthesis.

As an example, a high value of gain, e.g., 10 dBi from a phased array of radiating elements is provided. These radiating elements are designed to have the above gain within a certain beam width, such as 25 degrees, for instance, based on the sub-array definition.

With the gain and beam width defined, the number of sub-arrays is obtained, and hence the number of elements. To avoid grating lobes, about 0.4 times the wavelength spacing between the elements allows calculation of the size of the circumference of the circular array.

Advantageously, the use of such a phased array is that, since all sub-arrays are actively managed by one RFIC, the system is more efficient in terms of scheduling, and hence advantageously reduces the power consumption and latency compared to prior state-of-the-art systems employing multiple RFEMs.

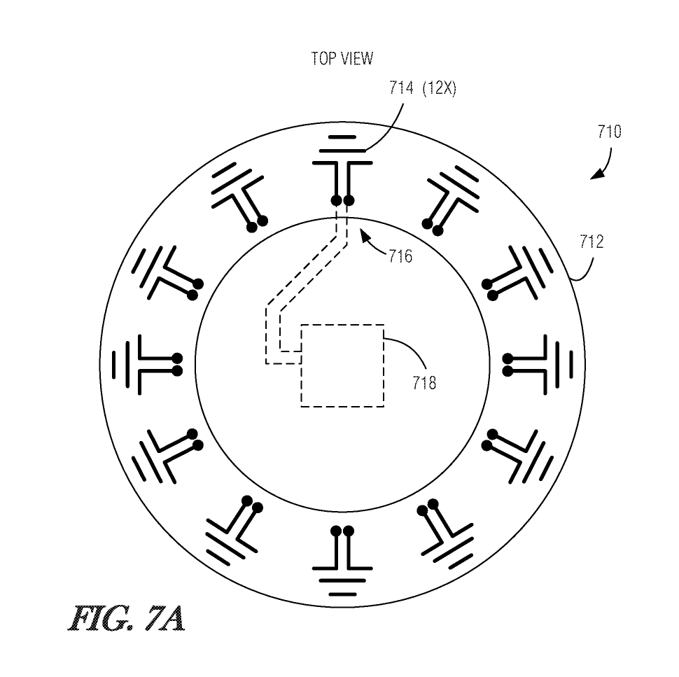

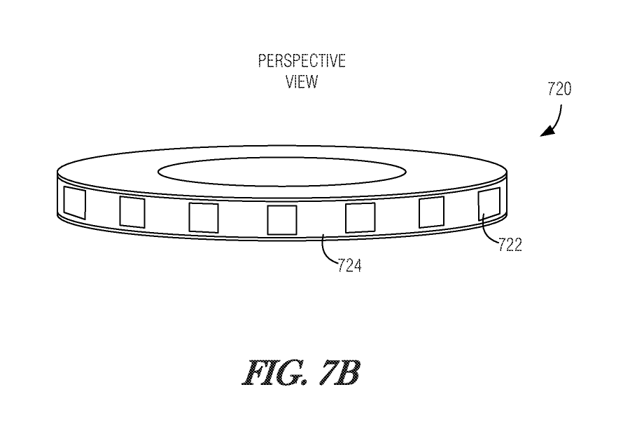

FIGS. 7A and 7B are diagrams illustrating example antenna arrangements of an antenna assembly according to various examples. In the example depicted in FIG. 7A, which is shown as a top-view diagram, RFEM 710 includes a printed circuit board 712 on which are formed a set of 12 radiating elements 714, which may be end-fire type antennas. As an example, radiating elements 714 may be Yagi-Uda or another suitable type of antenna that provides directional gain.

Each radiating element 714 is operatively coupled to RFEM 718, which may be situated on the printed circuit board 712, or elsewhere. Electrical coupling 716 may include one or more vias formed in printed circuit board 712 that allow RFEM 718 to be placed on the bottom side of the circuit board 712, or on a different circuit board that may be wired or connected to circuit board 712 using pins or other suitable connector. For purposes of clarity only one single electrical connection 716 is depicted in FIG. 7A. RFEM 718 may include a RFIC having 12 distinct RF chains, with each RF chain corresponding to one of the radiating elements 714.

An arrangement according to this example supports feeding radiating elements 714 using individual phase-offset signaling to produce a phased array implementation that may be employed to form and steer transmission or receive beams. As an example, each radiating element may have a gain of approximately 6 dBi. A subset of the 12 radiating elements 714 (e.g., a sub-array of 4 radiating elements 714) may be used in combination to further narrow the beam to achieve a gain of approximately 12 dBi.

FIG. 7B is a perspective-view diagram illustrating a radiating element arrangement of a RFEM according to another example. RFEM 720 includes a set of radiating elements 722 positioned around the circumference of the cylindrical body of RFEM 720. Radiating elements 722 may be planar antennas situated perpendicularly to the direction of transmitted wave propagation. In an example implementation, planar-antenna radiating elements 722 are mounted, or formed, on a flexible circuit substrate 724. Flexible circuit substrate 724 may comprise a polymeric material such as polyimide or polyester film of one or more layers. Radiating elements 722 may be formed as one or more etched metal layers on the flexible circuit substrate 724. In a related example, a signal-feed network (not shown) for the array of radiating elements 722 is a planar network situated on a plane perpendicular to the orientation of radiating elements 722.

The circular radiating-element arrays 710 and 720 according to either of the examples depicted in FIGS. 7A and 7B or, more generally, the arrangement of radiating elements 602A-602H of antenna assembly 502 depicted in FIGS. 5-6 can achieve a 360-degree azimuth of communications coverage. It is contemplated that some practical examples may provide communications coverage of approximately 140 degrees of elevation. In the present context, azimuth and elevation are given their customary meanings, with azimuth referring to coverage in the horizontal plane, and elevation referring to coverage in the vertical planes.

For certain VR usages, it may be desirable to expand the elevation coverage as there are various games and other applications that call for the user to look upwards towards the ceiling, or downwards towards the floor as the user actively observes a virtual world displayed in the HMD.

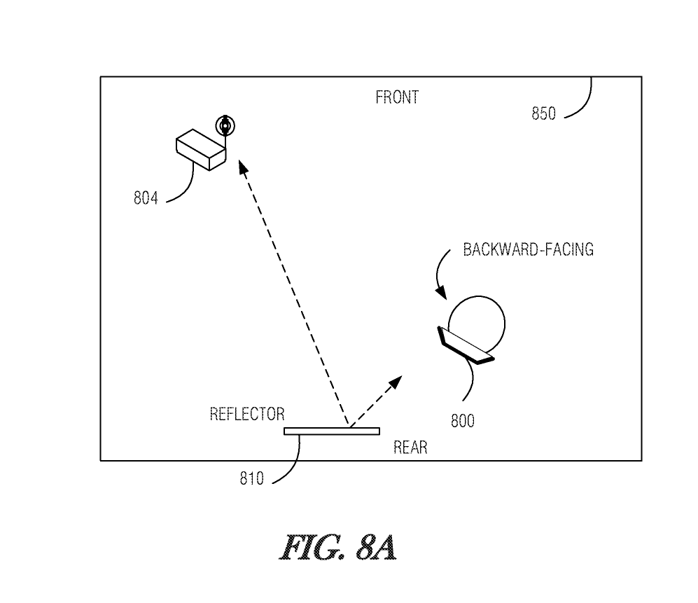

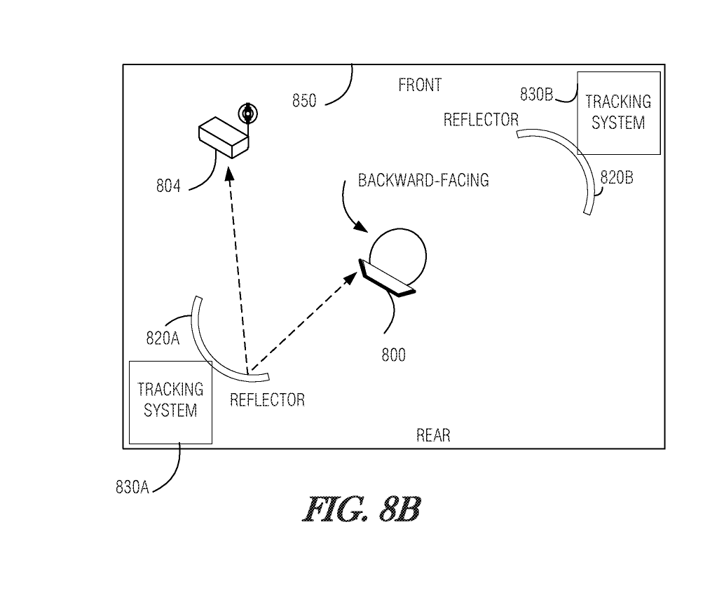

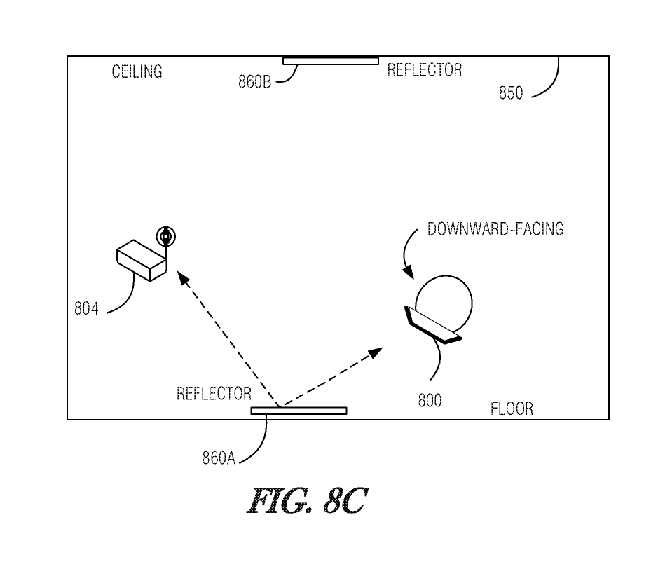

FIGS. 8A-8C are diagrams illustrating signal reflectors to improve communications coverage azimuth, elevation, or both, according to a related aspect.

FIG. 8A, reflector 810 may be positioned on an opposite side of room 850 from VR-content source 804 to improve communications coverage azimuth, particularly for HMDs having communication coverage azimuths that are non-isotropic, such as HMD 402 (FIG. 4). Reflector 810 may be formed or constructed from a reflective material, such as a metal sheet, metallic-coating on a polymeric substrate, or non-metallic conductive material or coating such as graphite. The reflective material may be placed near one or more corners of room 850.

FIG. 8B illustrates a related example that utilizes other components of the VR system, such as user-tracking systems placed at the corners of the room, to also serve as signal reflectors. As depicted, reflectors 820A and 820B are incorporated respectively in tracking systems 830A and 830B situated in different corners of room 850. Tracking systems 830A, 830B may be similar in their primary function to HTC VIVE lighthouses, for example. Reflectors 820A and 820B provide a secondary function of improving communications coverage. In various examples of installations, tracking systems 830 and reflectors 820 may be positioned at different elevations, such as at the top of a bookshelf, or on the floor, of room 850 to enhance elevational communications coverage. Reflector 820 may be concave, as depicted, according to some examples. In other examples, reflectors 820 are substantially planar, or convex at the reflecting surface.

In another example as illustrated in FIG. 8C, one or both of reflectors 860A and 860B may be placed on the floor or ceiling, respectively. Reflector 860A may be incorporated as part of a rug or floor mat, whereas reflector 860B may be incorporated as part of a light fixture in order to appear unobtrusive in room 850. Advantageously, a ceiling installation may provide better coverage and reduced likelihood of obstruction (e.g. by the user's hands/objects in room 850).

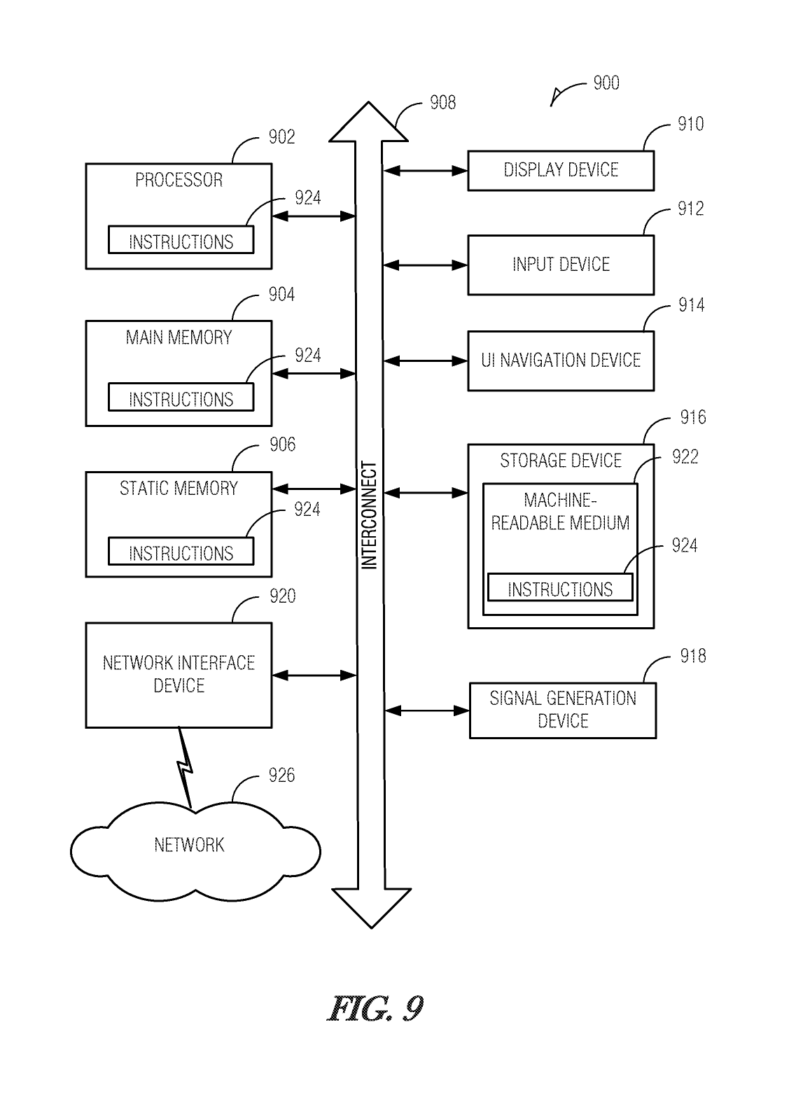

FIG. 9 illustrates a block diagram of an example machine 900 in accordance with some examples upon which any one or more of the techniques (e.g., methodologies) discussed herein may perform. In alternative examples, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a UE, eNodeB, AP, STA, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of circuits, components, modules, mechanisms, or engines (collectively, “engines”). Engines are tangible entities (e.g., hardware) capable of performing specified operations and may be configured or arranged in a certain manner. In an example, circuits may be arranged (e.g., internally or with respect to external entities such as other circuits) in a specified manner as an engine. In an example, the whole or part of one or more computer systems (e.g., a standalone, client or server computer system) or one or more hardware processors may be configured by firmware or software (e.g., instructions, an application portion, or an application) as an engine that operates to perform specified operations. In an example, the software may reside on a machine readable medium. In an example, the software, when executed by the underlying hardware of the engine, causes the hardware to perform the specified operations.

Accordingly, the term “engine” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which engines are temporarily configured, each of the engines need not be instantiated at any one moment in time. For example, where the engines comprise a general-purpose hardware processor configured using software, the general-purpose hardware processor may be configured as respective different engines at different times. Software may accordingly configure a hardware processor, for example, to constitute a particular engine at one instance of time and to constitute a different engine at a different instance of time.

Machine (e.g., computer system) may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The machine 900 may additionally include a storage device (e.g., drive unit) 916, a signal generation device 918 (e.g., a speaker), a network interface device 920, and one or more sensors, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR), near field communication (NFC), and the like.) connection to communicate or control one or more peripheral devices (e.g., a printer, card reader, and the like).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine and that cause the machine to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), and the like). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. In some examples, the network interface device 920 may wirelessly communicate using Multiple User MIMO techniques. The term “transmission medium” shall be taken to include any intangible medium that is capable of storing, encoding or carrying instructions for execution by the machine, and includes digital or analog communications signals or other intangible medium to facilitate communication of such software.

Various examples may include (without limitation) one or more of the following combinations:

Example 1 is a wireless head-mounted display (HMD) device to be worn on the head of a user, comprising: a HMD body including a display device and a head-mount structure, the HMD body including a top portion that is to be situated above the top of the head of the user when the HMD is worn by the user; at least one radio-frequency front-end module (RFEM) including radio-frequency transmission and reception circuitry; and an omnidirectional multi-antenna assembly situated at the top portion of the HMD body, the omnidirectional multi-antenna assembly having a generally cylindrical form factor defined by placement of a plurality of antenna elements that facilitate an omnidirectional azimuth configuration.

In Example 2, the subject matter of Example 1 optionally includes wherein the omnidirectional multi-antenna assembly includes a phased-array system of antenna elements.

In Example 3, the subject matter of any one or more of Examples 1-2 optionally include wherein the omnidirectional multi-antenna assembly includes a plurality of antenna elements, wherein subsets of the plurality of antenna elements are organized as sub-arrays.

In Example 4, the subject matter of Example 3 optionally includes 25 degrees of beam width.

In Example 5, the subject matter of any one or more of Examples 3-4 optionally include 0.4-wavelength distance.

In Example 6, the subject matter of any one or more of Examples 1-5 optionally include wherein the omnidirectional multi-antenna assembly includes a plurality of antenna elements arranged to produce a steerable directional outward-facing radiation pattern.

In Example 7, the subject matter of any one or more of Examples 1-6 optionally include wherein the omnidirectional multi-antenna assembly includes a plurality of end-firing directional radiating elements situated in an azimuth plane.

In Example 8, the subject matter of any one or more of Examples 1-7 optionally include wherein the omnidirectional multi-antenna assembly includes a plurality of patch antenna elements situated perpendicularly to an azimuth plane.

In Example 9, the subject matter of any one or more of Examples 1-8 optionally include wherein the omnidirectional multi-antenna assembly includes a housing portion, and radio front end module (RFEM) circuitry situated inside the housing portion and operatively coupled with the plurality of antenna elements.

In Example 10, the subject matter of any one or more of Examples 1-9 optionally include wherein the omnidirectional multi-antenna assembly includes a housing portion having a cylindrical shape.

In Example 11, the subject matter of any one or more of Examples 1-9 optionally include wherein the omnidirectional multi-antenna assembly includes a housing portion having a prismatic shape.

In Example 12, the subject matter of any one or more of Examples 1-11 optionally include 360 degrees of elevational coverage.

In Example 13, the subject matter of any one or more of Examples 1-12 optionally include a single RFEM having a single radio frequency integrated circuit.

In Example 14, the subject matter of any one or more of Examples 1-13 optionally include wherein the plurality of antenna elements are formed on a printed circuit board situated in an azimuth plane.

In Example 15, the subject matter of any one or more of Examples 1-14 optionally include wherein the plurality of antenna elements are formed on a printed flexible circuit substrate situated perpendicularly to an azimuth plane.

Example 16 is an omnidirectional antenna assembly for a wireless head-mounted display (HMD) device to be worn on the head of a user, the omnidirectional antenna assembly comprising: a generally cylindrical form factor defined by placement of a plurality of antenna elements that facilitate an omnidirectional azimuth configuration; and a housing adapted to be installed on a top portion of a HMD body, wherein the top portion is to be situated above the top of the head of the user when the HMD is worn by the user.

In Example 17, the subject matter of Example 16 optionally includes wherein the plurality of antenna elements includes a phased-array system of antenna elements.

In Example 18, the subject matter of any one or more of Examples 16-17 optionally include wherein subsets of the plurality of antenna elements are organized as sub-arrays.

In Example 19, each of the sub-arrays of Example 18 optionally includes 25 degrees of beam width.

In Example 20, each of the sub-arrays of any one or more of Examples 18-19 are optionally spaced at a 0.4-wavelength distance.

In Example 21, the subject matter of any one or more of Examples 16-20 optionally include wherein the plurality of antenna elements are arranged to produce a steerable directional outward-facing radiation pattern.

In Example 22, the subject matter of any one or more of Examples 16-21 optionally include wherein the plurality of antenna elements includes a plurality of end-firing directional radiating elements situated in an azimuth plane.

In Example 23, the subject matter of any one or more of Examples 16-22 optionally include wherein the plurality of antenna elements includes a plurality of patch antenna elements situated perpendicularly to an azimuth plane.

In Example 24, the subject matter of any one or more of Examples 16-23 optionally include wherein the housing contains radio front end module (RFEM) circuitry operatively coupled with the plurality of antenna elements.

In Example 25, the subject matter of any one or more of Examples 16-24 optionally include wherein the housing portion has a generally cylindrical shape.

In Example 26, the subject matter of any one or more of Examples 16-24 optionally include wherein the housing portion has a prismatic shape.

In Example 27, the subject matter of any one or more of Examples 16-26 is optionally configured to provide 360 degrees of azimuth at a distance of 1 meter and at least 140 degrees of elevational coverage.

In Example 28, the subject matter of any one or more of Examples 16-27 optionally include a single radio front end module having a single radio frequency integrated circuit.

In Example 29, the subject matter of any one or more of Examples 16-28 optionally include wherein the plurality of antenna elements are formed on a printed circuit board situated in an azimuth plane.

In Example 30, the subject matter of any one or more of Examples 16-29 optionally include wherein the plurality of antenna elements are formed on a printed flexible circuit substrate situated perpendicularly to an azimuth plane.

Example 31 is a wireless head-mounted display (HMD) device, comprising: a HMD body including a display device and a head-mount structure; a first directional antenna array and a second directional antenna array mechanically coupled to the HMD body, each directional antenna array being arranged to produce a corresponding range of beam directionality, wherein each range of beam directionality includes a forward-facing component and a side-facing component, and wherein portions of the ranges of beam directionality overlap in a forward-facing direction.

In Example 32, the subject matter of Example 31 optionally includes wherein each of the first and the second antenna arrays are mounted in spaced relationship with the HMD body, wherein the spaced relationship establishes a gap between the antenna array and the HMD body.

In Example 33, the subject matter of any one or more of Examples 31-32 optionally include wherein each of the first and the second antenna arrays are mounted on a common antenna carrier structure.

In Example 34, the subject matter of Example 33 optionally includes wherein the common antenna carrier structure includes an elongate straight segment and a pair of folded segments on opposite ends of the straight segment, and wherein the first and the second antenna arrays are each mounted on a respective folded segment.

In Example 35, each folded segment according to the subject matter of Example 34 optionally includes a 60-75-degree angle relative to the straight segment.

In Example 36, the range of beam directionality of each antenna array of the subject matter of any one or more of Examples 31-35 is 120 degrees.

In Example 37, the subject matter of any one or more of Examples 31-36 optionally include wherein each antenna array is part of a radio frequency front end module (RFEM).

In Example 38, the subject matter of any one or more of Examples 31-37 optionally include wherein each antenna array is configured for wireless gigabit (WiGig) technology utilizing millimeter-wave radio frequency communication.

Example 39 is a system for facilitating a wireless head-mounted display (HMD) device, comprising: a HMD device, including: a HMD body including a display device and a head-mount structure; and an antenna array mounted to the HMD body and coupled to a radio frequency communications circuit; and a VR-content source situated within communication range of the HMD device; and a reflector structure situated within communication range of the HMD device and the VR-content source, the reflector structure arranged to reflect a radio beam being propagated between the HMD device and the VR-content source.

In Example 40, the subject matter of Example 39 optionally includes wherein the reflector structure is situated on the ceiling of a room in which the system is configured.

In Example 41, the subject matter of any one or more of Examples 39-40 optionally include wherein the reflector structure is incorporated as part of a light fixture.

In Example 42, the subject matter of any one or more of Examples 39-41 optionally include wherein the reflector structure is situated on the floor of a room in which the system is configured.

In Example 43, the subject matter of any one or more of Examples 39-42 optionally include wherein the reflector structure is incorporated as part of a floor covering.

In Example 44, the subject matter of any one or more of Examples 39-43 optionally include wherein the reflector structure is incorporated as part of a tracking system device configured to monitor a user of the HMD device.

Example 45 is a wireless head-mounted display (HMD) device to be worn on the head of a user, comprising: a HMD body including a display device and a head-mount structure, the HMD body including a top portion that is to be situated above the top of the head of the user when the HMD is worn by the user; at least one radio-frequency front-end module (RFEM) including radio-frequency transmission and reception circuitry; and the omnidirectional antenna assembly according to any one of Examples 1-15 situated at the top portion of the HMD body.

Example 46 is a system for facilitating a wireless head-mounted display (HMD) device, comprising: a HMD device, including: a HMD body including a display device and a head-mount structure, the HMD body including a top portion that is to be situated above the top of the head of the user when the HMD is worn by the user; the omnidirectional antenna assembly according to any one of Examples 1-15 situated at the top portion of the HMD body; a VR-content source situated within communication range of the HMD device; and a reflector structure situated within communication range of the HMD device and the VR-content source, the reflector structure arranged to reflect a radio beam being propagated between the HMD device and the VR-content source.

In Example 47, the subject matter of Example 46 optionally includes wherein the reflector structure is situated on the ceiling of a room in which the system is configured.

In Example 48, the subject matter of any one or more of Examples 46-47 optionally include wherein the reflector structure is incorporated as part of a light fixture.

In Example 49, the subject matter of any one or more of Examples 46-48 optionally include wherein the reflector structure is situated on the floor of a room in which the system is configured.

In Example 50, the subject matter of any one or more of Examples 46-49 optionally include wherein the reflector structure is incorporated as part of a floor covering.

In Example 51, the subject matter of any one or more of Examples 46-50 optionally include wherein the reflector structure is incorporated as part of a tracking system device configured to monitor a user of the HMD device.

Example 52 is a subassembly for a wireless head-mounted display (HMD) device to be worn on the head of a user, the omnidirectional antenna assembly comprising: a generally cylindrical form factor defined by placement of a means for facilitating an omnidirectional azimuth configuration; and housing means for installation on a top portion of a HMD body, wherein the top portion is to be situated above the top of the head of the user when the HMD is worn by the user.

In Example 53, the subject matter of Example 52 optionally includes wherein the means for facilitating an omnidirectional azimuth configuration includes a phased-array system of antenna elements.

In Example 54, the subject matter of Example 53 optionally includes wherein subsets of the plurality of antenna elements are organized as sub-arrays.

In Example 55, the subject matter of Example 54 optionally includes degrees of beam width.

In Example 56, the subject matter of any one or more of Examples 54-55 optionally include -wavelength distance.

In Example 57, the subject matter of any one or more of Examples 52-56 optionally include wherein the means for facilitating an omnidirectional azimuth configuration are arranged to produce a steerable directional outward-facing radiation pattern.

In Example 58, the subject matter of any one or more of Examples 52-57 optionally include wherein the means for facilitating an omnidirectional azimuth configuration includes a plurality of end-firing directional radiating elements situated in an azimuth plane.

In Example 59, the subject matter of any one or more of Examples 52-58 optionally include wherein the means for facilitating an omnidirectional azimuth configuration includes a plurality of patch antenna elements situated perpendicularly to an azimuth plane.

In Example 60, the subject matter of any one or more of Examples 52-59 optionally include wherein the housing means contains radio front end module (RFEM) circuitry operatively coupled with the plurality of antenna elements.

In Example 61, the subject matter of any one or more of Examples 52-60 optionally include wherein the housing means has a generally cylindrical shape.

In Example 62, the subject matter of any one or more of Examples 52-61 optionally include wherein the housing means has a prismatic shape.

In Example 63, the subject matter of any one or more of Examples 52-62 optionally include degrees of elevational coverage.

In Example 64, the subject matter of any one or more of Examples 52-63 optionally include a single radio front end module having a single radio frequency integrated circuit.

In Example 65, the subject matter of any one or more of Examples 52-64 optionally include wherein the means for facilitating an omnidirectional azimuth configuration are formed on a printed circuit board situated in an azimuth plane.

In Example 66, the subject matter of any one or more of Examples 52-65 optionally include wherein the means for facilitating an omnidirectional azimuth configuration are formed on a printed flexible circuit substrate situated perpendicularly to an azimuth plane.

Example 67 is a wireless head-mounted display (HMD) device, comprising: a HMD body including a display device and head-mounting means; a first directional antenna array and a second directional antenna array mechanically coupled to the HMD body, each directional antenna array being arranged to produce a corresponding range of beam directionality, wherein each range of beam directionality includes a forward-facing component and a side-facing component, and wherein portions of the ranges of beam directionality overlap in a forward-facing direction.

In Example 68, the subject matter of Example 67 optionally includes wherein each of the first and the second antenna arrays are mounted in spaced relationship with the HMD body, wherein the spaced relationship establishes a gap between the antenna array and the HMD body.

In Example 69, the subject matter of any one or more of Examples 67-68 optionally include wherein each of the first and the second antenna arrays are mounted on a common antenna carrier structure.

In Example 70, the subject matter of Example 69 optionally includes wherein the common antenna carrier structure includes an elongate straight segment and a pair of folded segments on opposite ends of the straight segment, and wherein the first and the second antenna arrays are each mounted on a respective folded segment.

In Example 71, the subject matter of Example 70 optionally includes degree angle relative to the straight segment.

In Example 72, the subject matter of any one or more of Examples 67-71 optionally include degrees.

In Example 73, the subject matter of any one or more of Examples 67-72 optionally include wherein each antenna array is part of a radio frequency front end module (RFEM).

In Example 74, the subject matter of any one or more of Examples 67-73 optionally include wherein each antenna array is configured for wireless gigabit (WiGig) technology utilizing millimeter-wave radio frequency communication.

Example 75 is a wireless head-mounted display (HMD) device, comprising: a HMD body including a display device and a head-mount structure, the HMD body including a top portion arranged to be situated above a crown of a head when the HMD is worn; a radio-frequency front-end module (RFEM) including radio-frequency transmission and reception circuitry; and an omnidirectional multi-antenna assembly situated at the top portion of the HMD body, the omnidirectional multi-antenna assembly having a generally cylindrical form factor defined by placement of a plurality of antennas that facilitate an omnidirectional azimuth configuration, wherein the plurality of antennas are operatively coupled to the RFEM and distributed around a circumference of the cylindrical form factor along an azimuth plane.

In Example 76, the subject matter of Example 75 optionally includes wherein the plurality of antennas includes a phased-array system of radiating elements.

In Example 77, the subject matter of any one or more of Examples 75-76 optionally include wherein the plurality of antennas includes subsets of radiating elements organized as sub-arrays.

In Example 78, the subject matter of Example 77 optionally includes degrees of beam width.

In Example 79, the subject matter of any one or more of Examples 77-78 optionally include -wavelength distance.

In Example 80, the subject matter of any one or more of Examples 75-79 optionally include wherein the plurality of antennas are arranged to produce a steerable directional outward-facing radiation pattern.

In Example 81, the subject matter of any one or more of Examples 75-80 optionally include wherein the omnidirectional multi-antenna assembly includes a plurality of end-firing directional radiating elements situated along the azimuth plane.

In Example 82, the subject matter of any one or more of Examples 75-81 optionally include wherein the plurality of antennas include a plurality of patch antennas oriented perpendicularly to the azimuth plane.

In Example 83, the subject matter of any one or more of Examples 75-82 optionally include wherein the omnidirectional multi-antenna assembly includes a housing portion, and wherein the RFEM circuitry is situated inside the housing portion.

In Example 84, the subject matter of any one or more of Examples 75-83 optionally include wherein the omnidirectional multi-antenna assembly includes a housing portion having a cylindrical shape.

In Example 85, the subject matter of any one or more of Examples 75-84 optionally include wherein the omnidirectional multi-antenna assembly includes a housing portion having a prismatic shape.

In Example 86, the subject matter of any one or more of Examples 75-85 optionally include degrees of elevational coverage.

In Example 87, the subject matter of any one or more of Examples 75-86 optionally include wherein the plurality of antennas are formed on a printed circuit board situated in an azimuth plane.

In Example 88, the subject matter of any one or more of Examples 75-87 optionally include wherein the plurality of antennas are formed on a printed flexible circuit substrate situated perpendicularly to an azimuth plane.

Example 89 is a wireless head-mounted display (HMD) device, comprising: a HMD body including a display device and a head-mount structure; a first directional antenna array and a second directional antenna array mechanically coupled to the HMD body, each directional antenna array being arranged to produce a corresponding range of beam directionality, wherein each range of beam directionality includes a forward-facing component and a side-facing component, and wherein portions of the ranges of beam directionality overlap in a forward-facing direction; wherein each of the first and the second antenna arrays are mounted on a common antenna carrier structure that includes an elongate straight segment and a pair of angled segments on opposite ends of the straight segment, and wherein the first and the second antenna arrays are each mounted on a respective angled segment.

In Example 90, the subject matter of Example 89 optionally includes wherein each of the first and the second antenna arrays are mounted in spaced relationship with the HMD body, wherein the spaced relationship establishes a gap between the antenna array and the HMD body.

In Example 91, the subject matter of any one or more of Examples 89-90 optionally include wherein the pair of angled segments are formed as folds at the respective opposite ends of the straight segment.

In Example 92, the subject matter of any one or more of Examples 89-91 optionally include degree angle relative to the straight segment.

In Example 93, the subject matter of any one or more of Examples 89-92 optionally include degrees.

Example 94 is an environment for facilitating communications with a wireless head-mounted display (HMD) device, the environment comprising: a VR-content source situated within communication range of a HMD device; and a reflector structure situated within communication range of the HMD device and the VR-content source, the reflector structure arranged to reflect a radio beam being propagated between the HMD device and the VR-content source.

In Example 95, the subject matter of Example 94 optionally includes wherein the reflector structure is situated on the ceiling of a room in which the system is configured.

In Example 96, the subject matter of any one or more of Examples 94-95 optionally include wherein the reflector structure is incorporated as part of a light fixture.

In Example 97, the subject matter of any one or more of Examples 94-96 optionally include wherein the reflector structure is situated on the floor of a room in which the system is configured.

In Example 98, the subject matter of any one or more of Examples 94-97 optionally include wherein the reflector structure is incorporated as part of a floor covering.

In Example 99, the subject matter of any one or more of Examples 94-98 optionally include wherein the reflector structure is incorporated as part of a tracking system device configured to monitor a user of the HMD device.

The above detailed description includes references to the accompanying drawings, which form a part of the detailed description. The drawings show, by way of illustration, specific examples in which the subject matter can be practiced. All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other examples can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description, with each claim standing on its own as a separate example. The scope of the subject matter should be determined with reference to the appended claims, along with the full scope of equivalents to which such claims are entitled.

1-25. (canceled)

26. A wireless head-mounted display (HMD) device, comprising:
a HMD body including a display device and a head-mount stricture, the HMD body including a top portion arranged to be situated above a crown of a head when the HMD is worn;
a radio-frequency front-end module (RFEM) including radio-frequency transmission and reception circuitry; and
an omnidirectional multi-antenna assembly situated at the top portion of the HMD body, the omnidirectional multi-antenna assembly having a generally cylindrical form factor defined by placement of a plurality of antennas that facilitate an omnidirectional azimuth configuration, wherein the plurality of antennas are operatively coupled to the RFEM and distributed around a circumference of the cylindrical form factor along an azimuth plane.

27. The HMD device of claim 26, wherein the plurality of antennas includes a phased-array system of radiating elements.

28. The HMD device of claim 26, wherein the plurality of antennas includes subsets of radiating elements organized as sub-arrays.

29. The HMD device of claim 28, wherein each of the sub-arrays provides 25 degrees of beam width.

30. The HMD device of claim 28, wherein each of the sub-arrays is spaced at a 0.4-wavelength distance.

31. The HMD device of claim 26, wherein the plurality of antennas are arranged to produce a steerable directional outward-facing radiation pattern.

32. The HMD device of claim 26, wherein the omnidirectional multi-antenna assembly includes a plurality of end-firing directional radiating elements situated along the azimuth plane.

33. The HMD device of claim 26, wherein the plurality of antennas include a plurality of patch antennas oriented perpendicularly to the azimuth plane.

34. The HMD device of claim 26, wherein the omnidirectional multi-antenna assembly includes a housing portion, and wherein the RFEM circuitry is situated inside the housing portion.

35. The HMD device of claim 26, wherein the omnidirectional multi-antenna assembly includes a housing portion having a cylindrical shape.

36. The HMD device of claim 26, wherein the omnidirectional multi-antenna assembly includes a housing portion having a prismatic shape.

37. The HMD device of claim 26, wherein the omnidirectional multi-antenna assembly is configured to provide 360 degrees of azimuth at a distance of at least 1 meter and at least 140 degrees of elevational coverage.

38. The HMD device of claim 26, wherein the plurality of antennas are formed on a printed circuit board situated in an azimuth plane.

39. The HMD device of claim 26, wherein the plurality of antennas are formed on a printed flexible circuit substrate situated perpendicularly to an azimuth plane.

40. A wireless head-mounted display (HMD) device, comprising:
a HMD body including a display device and a head-mount structure;
a first directional antenna array and a second directional antenna array mechanically coupled to the HMD body, each directional antenna array being arranged to produce a corresponding range of beam directionality, wherein each range of beam directionality includes a forward-facing component and a side-facing component, and wherein portions of the ranges of beam directionality overlap in a forward-facing direction;
wherein each of the first and the second antenna arrays are mounted on a common antenna carrier structure that includes an elongate straight segment and a pair of angled segments on opposite ends of the straight segment, and wherein the first and the second antenna arrays are each mounted on a respective angled segment.

41. The HMD device of claim 40, wherein each of the first and the second antenna arrays are mounted in spaced relationship with the HMD body, wherein the spaced relationship establishes a gap between the antenna array and the HMD body.

42. The HMD device of claim 40, wherein the pair of angled segments are formed as folds at the respective opposite ends of the straight segment.

43. The HMD device of claim 40, wherein each angled segment is at a 60-75 degree angle relative to the straight segment.

44. The HMD device of claim 40, wherein the range of beam directionality of each antenna array is 120 degrees.

45. An environment for facilitating communications with a wireless head-mounted display (HMD) device, the environment comprising:
a VR-content source situated within communication range of a HMD device; and
a reflector structure situated within communication range of the HMD device and the VR-content source, the reflector structure arranged to reflect a radio beam being propagated between the HMD device and the VR-content source.

46. The system of claim 45, wherein the reflector structure is situated on the ceiling of a room in which the system is configured.

47. The system of claim 45, wherein the reflector structure is incorporated as part of a light fixture.

48. The system of claim 45, wherein the reflector structure is situated on the floor of a room in which the system is configured.

49. The system of claim 45, wherein the reflector structure is incorporated as part of a floor covering.

50. The system of claim 45, wherein the reflector structure is incorporated as part of a tracking system device configured to monitor a user of the HMD device.
